(19) United States
(12) Patent Application Publication
(10) Pub. No.: US 2024/0275565 A1
(43) Pub. Date: Aug. 15, 2024

(54) WIRELESS COMMUNICATION SYSTEM, WIRELESS COMMUNICATION METHODS, ACCESS POINT APPARATUS AND PROGRAM

(71) Applicant: NIPPON TELEGRAPH AND TELEPHONE CORPORATION, Tokyo (JP)

(72) Inventors: Shoko SHINOHARA, Musashino-shi, Tokyo (JP); Tomoyuki YAMADA, Musashino-shi, Tokyo (JP); Yusuke ASAI, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 18/567,429

(22) PCT Filed: Jun. 10, 2021
(86) PCT No.: PCT/JP2021/022175

§ 371 Date: Dec. 7, 2023

(51) Int. Cl. H04L 5/00; H04W 72/23; H04W 72/51

(52) U.S. Cl. CPC H04L 5/0087; H04L 5/0037; H04W 72/23; H04W 72/51

(57) ABSTRACT

In a wireless communication system in which an AP 1 and a plurality of STAs 2 perform wireless communication, the AP 1 notifies each of the STAs 2 of a schedule of channel transition including a transition destination channel and a timing of channel transition different for each of the STAs 2 (or each group thereof), and then executes a channel switching process, and when the STA 2 receives the schedule of channel transition, the STA 2 stops transmission, and thereafter executes a connection process with the AP 1 at the timing according to the schedule. It is possible to shorten the time until the communication with the AP is resumed by avoiding collision of wireless frames between the terminals (STAs) when the channel is changed.

### TECHNICAL FIELD

Embodiments of the present invention relate generally to a wireless communication system, a wireless communication method, an access point device, and a program.

### BACKGROUND ART

A wireless communication system including a base station and a terminal is known.

A typical example of the wireless communication system is a wireless local area network (LAN) for public use. As the wireless LAN for public use, for example, a use case in which data is transmitted from a base station to a public computer terminal and a smartphone terminal is assumed. Furthermore, with the recent spread of Internet of Things (IoT) terminals, use cases in which data is transmitted from the terminal side are increasing.

As a wireless communication system for the IoT, a wireless communication system using an unlicensed Sub-1 GHz band is systematized in many countries around the world. Among others, in Japan, a 920 MHz band is allocated as a frequency band of an electronic tag system. Among them, what is called low power wide area (LPWA) wireless communication systems such as Long Range (LoRa) and Wireless Smart Utility Network (Wi-SUN) are used as an active electronic tag system. In addition, use of IEEE 802.11ah, which is one of wireless LAN standards, has also been studied.

Since the number of frequency channels is limited in the 920 MHz band, a case of operating while changing the channel is considered.

In the wireless LAN, before starting communication between an access point device (AP) as a master device and a station device (STA), it is necessary to exchange frames for starting connection.

Also in a case of switching the channel, it is necessary to perform frame exchange for starting connection in the channel after switching (after transition) or to support a sequence for channel switching (for example, Channel Switch Announcement (CSA) of IEEE 802.11h or Extended Channel Switch Announcement (ECSA) of IEEE 802.11y).

Both the AP and the STA need to support the sequence for channel switching. If the AP and the STA support the sequence, channel transition can be performed while maintaining connection information, and the time for channel switching can be minimized because the frame exchange is unnecessary. Further, by providing notification of channel transition information using the field of Vender Specific or the field of Reserved of the wireless LAN frame, the channel transition can be performed while the connection information is maintained.

However, in a case where the sequence as described above is not supported, or in a case where only a predetermined operation can be performed by the wireless module in advance, STAs that need to be connected attempt to exchange frames for starting connection with the AP all at once after switching the channel. Thus, frame collision occurs, and consequently, it takes time from the start of channel switching to the completion of connection. Alternatively, if the terminal supports Fast Initial Link Setup (FILS) of IEEE 802.11ai at the start of connection, the connection process can be simplified and the time until the connection is completed can be shortened. However, terminals (STA) for IoT are highly demanded to be manufactured at low cost, and therefore it is difficult for all the terminals to support FILS.

### CITATION LIST

### Non Patent Literature

Non Patent Literature 1: ARIB STD-T108 1.3, “920 MHz-Band Telemeter, Telecontrol and Data Transmission Radio Equipment and Standards”, Apr. 12, 2019 Non Patent Literature 2: IEEE Std 802.11ah TM-2016 (IEEE Standard for Information technology—Telecommunications and information exchange between systems Local and metropolitan area networks—Specific requirements, Part 11: Wireless LAN Medium Access Control (MAC) and Physical Layer (PHY) Specifications, Amendment 2: Sub 1 GHz License Exempt Operation, IEEE Computer Society, 7 Dec. 2016

### SUMMARY OF INVENTION

### Technical Problem

Since the wireless LAN standard of the 920 MHz band (IEEE 802.11ah) has a wider area as a communication range than the wireless LAN of the 2.4 GHz band or the 5 GHz band that has been used conventionally, the time length per symbol of a wireless signal is long as a countermeasure against fading. In addition, since the channel bandwidth is also narrow, the wireless frame time length becomes long.

Accordingly, in a case where a basic service set (BSS: a cell including an AP and STAs), which is a 920 MHz band, changes the channel, it takes time for a plurality of terminals (STAs) to complete connection to the AP. In particular, in a case where the number of terminals (STA) is large, there is an increased possibility that wireless frames from the STAs that require a connection process collide with each other, and accordingly, the time taken until connection is completed and communication can be started is extended.

The present invention has been made in view of the above circumstances, and an object thereof is to provide a wireless communication system, a wireless communication method, an access point device, and a program that can shorten a time until communication with an AP is resumed by avoiding collision of wireless frames between terminals (STAs) when a channel is changed.

### Solution to Problem

A wireless communication system according to an embodiment is a wireless communication system in which an access point device and a plurality of station devices perform wireless communication, in which
the access point device includes
a first processor that, after notifying the plurality of station devices of a schedule of channel transition including identification information of a transition destination channel and a timing of channel transition different for each of station devices or each group of station devices, executes a switching process to the transition destination channel, and
the station devices each include
a second processor that, after stopping transmission in response to the notification of the schedule of channel transition from the access point device, executes a connection process with the access point device at the timing of channel transition on the transition destination channel according to the schedule of channel transition notification of which is provided.

### Advantageous Effects of Invention

According to the embodiments of the present invention, it is possible to shorten a time until communication with an AP is resumed by avoiding collision of wireless frames between terminals (STAs) when a channel is changed.

### BRIEF DESCRIPTION OF DRAWINGS

FIG. 1 is a block diagram illustrating an overall configuration of a wireless communication system according to an embodiment of the present invention.

FIG. 2 is a block diagram illustrating a configuration of a wireless communication control device 10 in the wireless communication system.

FIG. 3 is a diagram illustrating an example of a transmission time of a wireless frame according to channel transition of the wireless communication system.

FIG. 4 is a functional block diagram illustrating a control function according to a wireless communication control program of the wireless communication control device 10.

FIG. 5 is a flowchart illustrating operations of an AP 1 and an STA 2 according to control processing by the wireless communication control device 10 (or 10, 20) of the wireless communication system.

### DESCRIPTION OF EMBODIMENTS

Hereinafter, a wireless communication system, a wireless communication method, an access point device, and a program according to embodiments will be described with reference to the drawings.

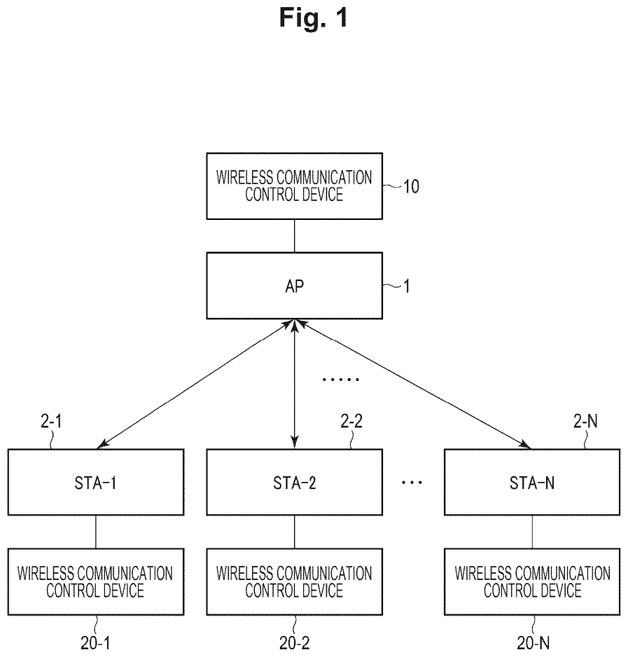

FIG. 1 is a block diagram illustrating an overall configuration of a wireless communication system according to an embodiment of the present invention.

The wireless communication system of the embodiment includes an access point device (AP) 1 that is a master device of a wireless local area network (LAN), and a plurality of station devices (STAs) 2-1, 2-2, . . . , and 2-N, and one or more STAs 2-1, 2-2, . . . , and 2-N are connected to the AP 1 to perform communication.

Here, a cell including the AP 1 and the STAs 2-1, 2-2, . . . , and 2-N is referred to as a basic service set (BSS).

The wireless communication control devices 10 and 20-1, 20-2, . . . , and 20-N are connected to the AP 1 and the STAs 2-1, 2-2, . . . , and 2-N, respectively. Each of the wireless communication control devices 10, 20-1, 20-2, . . . , and 20-N has a function of exchanging wireless environment information and control commands.

Note that the wireless communication control device 10 connected to the AP 1 does not need to be connected to the outside in a case where a wireless communication control program thereof is mounted in the AP 1. Further, the wireless communication control devices 20-1, 20-2, . . . , and 20-N connected to the STAs 2-1, 2-2, . . . , and 2-N do not need to be connected to the outside in a case where a wireless communication control program thereof is mounted in the STAs 2-1, 2-2, . . . , and 2-N.

The wireless communication control program corresponding to the AP 1 and each of the STAs 2-1, 2-2, . . . , and 2-N may operate independently while performing synchronization among the wireless communication control devices 10, 20-1, 20-2, . . . , and 20-N, or may operate independently while performing synchronization between the AP 1 and each of the STAs 2-1, 2-2, . . . , and 2-N in a case where the wireless communication control program is mounted in the same AP 1 and each of the STAs 2-1, 2-2, . . . , and 2-N.

In addition, the wireless communication control device 10 connected to the AP 1 may operate to collectively manage and control up to the total transmission time of each of the STAs 2-1, 2-2, . . . , and 2-N. In a case where the wireless communication control device 10 connected to the AP 1 collectively performs monitoring of the wireless communication system and determination and decision of the timing of channel transition (change), the wireless communication control device performs control to perform determination and decision on the basis of transmission statuses of the STAs and the APs of other BBS.

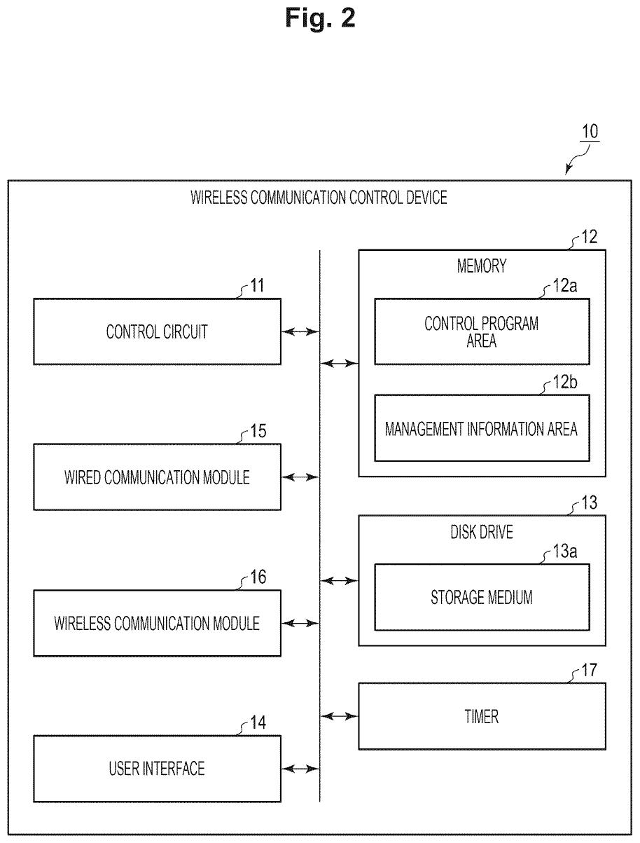

FIG. 2 is a block diagram illustrating a hardware configuration of the wireless communication control device 10 in the wireless communication system.

The wireless communication control device 10 includes a control circuit (processor) 11.

A memory 12 such as a flash ROM, a hard disk drive 13 including a storage medium 13a such as a magnetic disk, a user interface 14 including a key, a switch, and an external input terminal for a user to operate from the outside, a wired communication module 15 or (and) a wireless communication module 16 for performing communication with the outside, a timer 17 for managing a transition time of a channel, and the like are connected to the control circuit 11 via a system and a data bus.

The control circuit 11 controls the operation of each unit of the wireless communication control device 10 on the basis of management information stored in or read from a management information area 12b of the memory 12 according to the wireless communication control program stored in a control program area 12a of the same memory 12.

The wireless communication control devices 20-1, 20-2, . . . , and 20-N of the STAs 2-1, 2-2, . . . , and 2-N are also configured by hardware similar to that of the wireless communication control device 10 of the AP 1 illustrated in FIG. 2.

The wireless communication control program stored in the control program area 12a of the wireless communication control device 10 of the AP 1 includes the following functions (a) to (d) for controlling the AP 1.
(a) A function for determining whether or not transition of a channel is necessary in the AP 1. Note that for the function of determining whether or not transition of a channel is necessary and determining the channel, the function of the STA 2 may be used.
(b) A function for deciding a schedule of channel transition including a transition destination channel and a timing of channel transition different for each STA, and notifying the wireless communication control device 20 of each STA 2 of the decided schedule in a case where it is determined that transition of the channel is necessary.
(c) A function for causing the AP 1 to execute switching of a channel according to a schedule of channel transition in a state in which transmission from the STA 2 is stopped before switching of the channel of the STA 2 by the wireless communication control device 20 of the same STA 2 that has been notified of the schedule of channel transition. Note that, here, the function may include a function for restarting the AP 1 to reflect setting values of the channel, the bandwidth, and the like associated with switching (changing) of the channel in the wireless communication module of the AP 1, and a function for setting the AP 1 to a stealth mode (Service Set ID (SSID) stealth) in order to make it difficult to receive unscheduled access from the surrounding STAs.
(d) A function for determining completion of communication connection according to a schedule of channel transition of each of the STAs 2-1, 2-2, . . . , and 2-N and canceling the setting of the stealth mode when the wireless communication control device 20 of the STA 2 that has been notified of the schedule of channel transition executes switching of the channel of the STA 2 at the timing according to the schedule and starts communication connection with the AP 1.

Further, the wireless communication control program stored in a control program area of the wireless communication control devices 20-1, 20-2, . . . , and 20-N of the STAs 2-1, 2-2, . . . , and 2-N includes the following functions (e) and (f) for controlling the STA 2.
(e) A function of stopping transmission from the STA 2 before switching of the channel of the same STA 2 on the basis of the schedule of channel transition notification of which is provided from the AP 1.
(f) A function of causing the STA 2 to execute switching of the channel at a timing according to a schedule of channel transition notification of which is provided from the AP 1 and to start communication connection with the AP 1 on the basis of the schedule.

Note that, in a case where the wireless communication control device 10 of the AP 1 collectively manages and controls each of the STAs 2-1, 2-2, . . . , and 2-N, the wireless communication control program of the wireless communication control device 10 includes the functions of (a) to (d) and (e) and (f) described above.

Note that the AP 1 and the STAs 2-1, 2-2, . . . , and 2-N are basically configured by hardware including a control circuit (processor), a memory, a user interface, a wired communication module, or (and) a wireless communication module, or the like, similarly to the wireless communication control device 10 of the AP 1 illustrated in FIG. 2.

Then, in a case where the wireless communication control program included in the wireless communication control device 10 of the AP 1 is mounted in the AP 1, the same wireless communication control program may be stored together with, for example, an AP control program for executing a predetermined operation as the AP (access point device) 1 stored in advance in a control program area of the memory in the AP 1. In this case, the AP 1 independently has the function of the wireless communication control device 10.

In addition, in a case where the wireless communication control program included the wireless communication control device 20-1, 20-2, . . . , or 20-N of the STAs 2-1, 2-2, . . . , or 2-N is mounted in the STA, the wireless communication control program may be stored together with, for example, an STA control program for executing a predetermined operation as the STA (station device) 2 stored in advance in a control program area of the memory in the STA 2. In this case, the STA 2 independently has the function of the wireless communication control device 20.

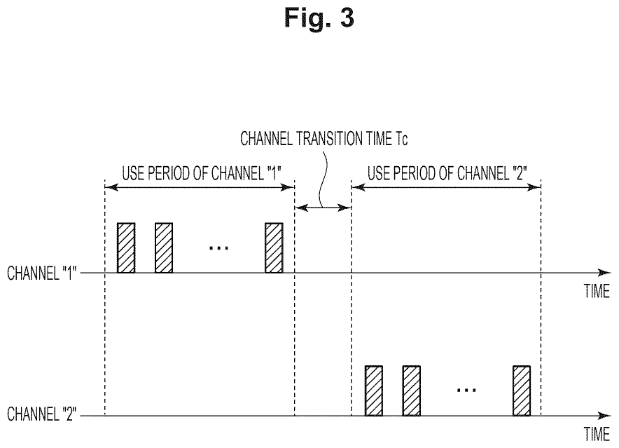

FIG. 3 is a diagram illustrating an example of a transmission time of a wireless frame according to channel transition of the wireless communication system.

In addition to avoiding a channel with a high utilization rate and avoiding interference with other radio wave signals, the transition of the channel is necessary for satisfying a restriction on the total transmission time per hour based on radio wave-related laws.

Here, it is assumed that a channel “1” and a channel “2” exist as different channels, and it is assumed that the AP 1 and the STA 2 switch between the two channels “1” or “2” to perform transition of the channels.

First, the AP 1 and the STA 2 communicate by exchanging wireless frames using the channel “1”. Then, in a case where the channel “2” is decided to be used for transmission due to a necessity of transition of the channel, communication of the channel “1” is stopped, and transition to the channel “2” is made to perform communication.

In this manner, the total transmission time per hour using the channel can be suppressed, but communication cannot be performed during the time after the transition (switching) of the channel is started until the STA 2 completes connection to the AP 1 (channel transition time Tc).

Accordingly, in the wireless communication system of the embodiment, a time until communication with the AP 1 is resumed is shortened by reducing collision of wireless frames between the STAs 2 when the channel is transitioned.

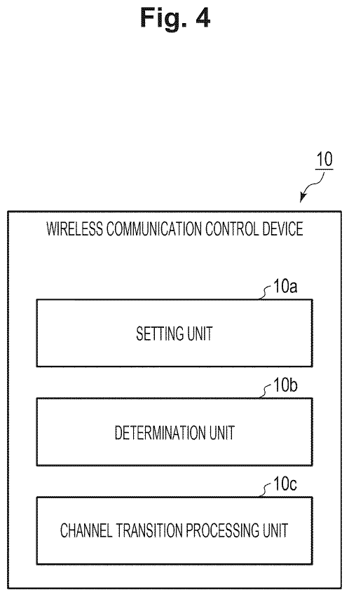

FIG. 4 is a block diagram illustrating a control function according to a wireless communication control program of the wireless communication control device 10.

The wireless communication control device 10 includes a setting unit 10a, a determination unit 10b, and a channel transition processing unit 10c as functions executed by the control circuit 11 according to the wireless communication control program.

For example, in cooperation with the AP 1, the setting unit 10a performs processing for setting (including default) the management information necessary for deciding a schedule of channel transition, such as an available channel, a timing (time, a communication state, or the like) at which necessity of channel transition is determined, a reference value of the necessity determination, and a timing (time) at which switching of the channel is started, according to an operation from the user interface 14.

For example, the determination unit 10b performs determination processing including determination of necessity of channel transition, determination of a timing of channel switching, and determination of a connection state with the STA 2 on the basis of the management information set by the setting unit 10a.

The channel transition processing unit 10c performs processing corresponding to the functions (a) to (d) or the functions (a) to (f) described above, for example, in cooperation with the processing in the setting unit 10a and the determination unit 10b.

In the wireless communication system configured as described above, the control circuit of the wireless communication control device 10 (or 10, 20) controls the operation of each unit in cooperation with the AP 1 and the STA 2 according to a command described in the wireless communication control program, and the software and the hardware operate in cooperation with each other, thereby implementing a channel switching function as described in the operation description as described later.

Next, an operation of the wireless communication system of the embodiment will be described.

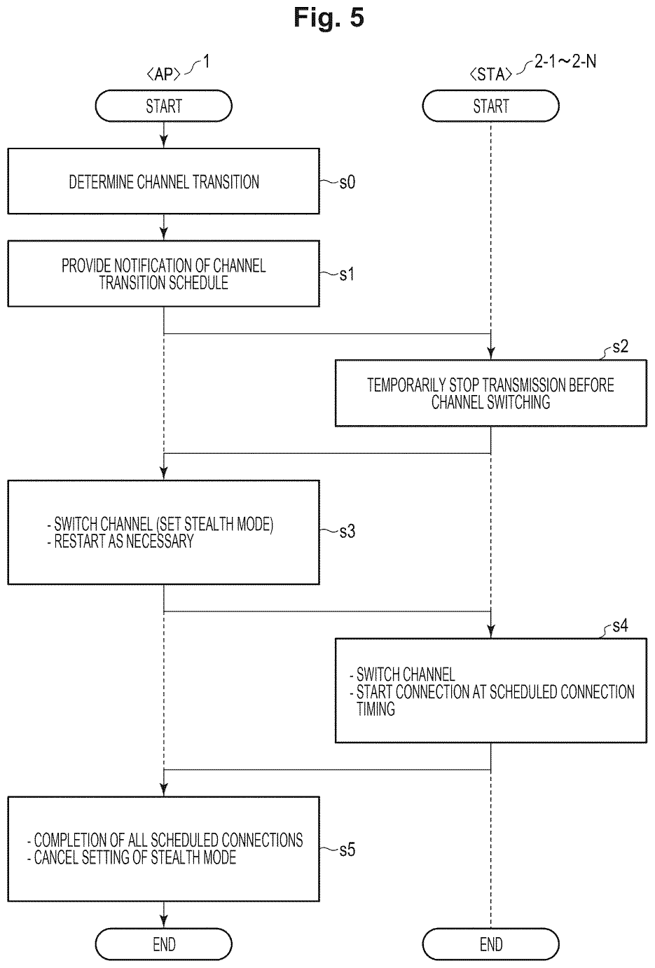

FIG. 5 is a flowchart illustrating operation of the AP 1 and the STA 2 according to control processing by the wireless communication control device 10 (or 10, 20) of the wireless communication system.

For example, the AP 1 determines whether or not channel transition is necessary at a timing of determining whether or not the channel transition set in the management information is necessary (step S0).

In step S0, when it is determined that channel transition is necessary, the AP 1 decides the schedule of channel transition including the transition destination channel (channel identification information) and a timing of channel transition different for each STA 2, and notifies each STA 2 of the decided schedule (channel transition schedule information) (step S1). Thus, the schedule of channel transition can be shared by the entire BSS.

When the STA 2 is notified of the schedule of channel transition from the AP 1, transmission from the same STA 2 is stopped before switching of the channel is performed on the basis of the timing of channel transition included in the schedule of channel transition notification of which is provided (step S2). The transmission may be stopped by stopping the operation of the wireless communication module or by stopping the input of packets to the wireless communication module.

The AP 1 executes switching of the channel according to the transition destination channel (channel identification information) and the channel transition timing included in the schedule of channel transition decided in step S1 (step S3).

At this time, in the AP 1, in a case where restart is necessary to reflect the setting values of the channel, the bandwidth, and the like associated with switching (changing) of the channel in the wireless communication module, the restart is executed.

In addition, in a case where the AP 1 has a setting function of the stealth mode (SSID stealth), the stealth mode is set. Note that the stealth mode includes at least one of a function of not including the SSID in the beacon packet or a function of not responding with the SSID to a probe request packet (ANY connection) in which the SSID is emptied in the wireless LAN.

By setting the stealth mode, it is possible to suppress the possibility of receiving an unscheduled access from a peripheral terminal (STA 2) that scans (passively scans) a channel depending on beacon information and is connected.

Furthermore, in the stealth mode, it is possible to clearly control the order of the STA 2 to complete connection according to the schedule of channel transition by setting so that it is not possible to connect to the STA 2 that has not reached the timing of channel transition on the basis of the timing of channel transition for each STA 2 or each group of STAs 2 included in the schedule of channel transition.

On the basis of the schedule of channel transition notification of which is provided from the AP 1, the STA 2 switches the channel at the timing according to the same schedule, designates the AP 1 to be connected to a probe request by active scanning, and starts connection with the AP 1 (step S4).

In this manner, by determining the connection timing of the STA 2 in advance according to the schedule of channel transition, it is possible to avoid collision of wireless frames between the STAs 2 and quickly complete the connection.

In the AP 1, when connection with each of the STAs 2 is completed by responding with a probe response to the probe request from each of the STAs 2 according to the schedule of channel transition, the setting of the stealth mode is canceled, and a state of being connectable to the STA 2 connected by passive scanning is set (step S5).

Therefore, with the wireless communication system, the wireless communication method, the access point device, and the program of the embodiment, in the wireless communication system in which the AP 1 and the plurality of STAs 2 perform wireless communication, the AP 1 performs the channel switching process after notifying each STA 2 of the schedule of channel transition including the transition destination channel and the timing of channel transition different for each STA 2 (or each group thereof), and the STA 2 stops transmission upon receiving the schedule of channel transition and then executes the connection process with the AP 1 at the timing according to the schedule. Thus, it is possible to shorten the time until communication with the AP is resumed by avoiding collision of wireless frames between the terminals (STA) when the channel is changed, and moreover, the communication capacity can be increased.

Therefore, even in a case where the conventional channel transition technology and connection process are not supported, it is possible to complete reconnection with channel transition between the AP and each STA in a short time.

Note that the methods described in the embodiments can be stored in a recording medium such as a magnetic disk (Floppy (registered trademark) disk, hard disk, and the like), an optical disc (CD-ROM, DVD, MO, and the like), or a semiconductor memory (ROM, RAM, flash memory, and the like) as a program (software means) that can be executed by a computer, and can be distributed by being transmitted through a communication medium. The programs stored on the medium side also include a setting program for configuring, in the computer, a software means (including not only an execution program but also tables and data structures) to be executed by the computer. The computer that implements the present device executes the above-described processing by reading the programs recorded in the recording medium, constructing the software means by the setting program as needed, and controlling the operation by the software means. The recording medium is not limited to a recording medium for distribution and includes a storage medium such as a magnetic disk or a semiconductor memory provided in the computing machine or in a device connected via a network.

The present invention is not limited to the above embodiments, and various modifications can be made in the implementation stage without departing from the gist thereof. In addition, the embodiments may be implemented in appropriate combination, and in that case, combined effects can be obtained. Furthermore, the embodiments described above include various inventions, and various inventions can be extracted by a combination selected from a plurality of disclosed components. For example, even if some components are eliminated from all the components described in the embodiment, in a case where the problem can be solved and the advantageous effects can be obtained, a configuration from which the components are eliminated can be extracted as an invention.

### REFERENCE SIGNS LIST

1 access point device (AP)
2-1 to 2-N station device (STA)
10, 20-1 to 20N wireless communication control device
11 control circuit (processor)
12 memory
12a control program area
12b management information area
13 disk drive
13a storage medium
14 user interface
15 wired communication module
16 wireless communication module
17 timer

1. A wireless communication system in which an access point device and a plurality of station devices perform wireless communication, wherein:
the access point device includes
a first processor that, after notifying the plurality of station devices of a schedule of channel transition including identification information of a transition destination channel and a timing of channel transition different for each of station devices or each group of station devices, executes a switching process to the transition destination channel, and
the station devices each include
a second processor that, after stopping transmission in response to the notification of the schedule of channel transition from the access point device, executes a connection process with the access point device at the timing of channel transition on the transition destination channel according to the schedule of channel transition notification of which is provided.

2. The wireless communication system according to claim 1,
wherein:
the first processor of the access point device sets a stealth mode accompanying execution of the switching process to the transition destination channel, and
cancels the set stealth mode after connection with the station device according to the schedule of channel transition is completed.

3. The wireless communication system according to claim 1, wherein:
a first processor of the access point device restarts accompanying execution of the switching process to the transition destination channel.

4. A wireless communication method by which an access point device and a plurality of station devices perform wireless communication, the wireless communication method comprising:
by a processor of the access point device,
after notifying the plurality of station devices of a schedule of channel transition including identification information of a transition destination channel and a timing of channel transition different for each of station devices or each group of station devices, executing a switching process to the transition destination channel; and
by a processor of each of the station devices,
after stopping transmission in response to the notification of the schedule of channel transition from the access point device, executing a connection process with the access point device at the timing of channel transition on the transition destination channel according to the schedule of channel transition notification of which is provided.

5. The wireless communication method according to claim 4, further comprising:
by the processor of the access point device,
setting a stealth mode accompanying execution of the switching process to the transition destination channel, and
canceling the set stealth mode after connection with the station device according to the schedule of channel transition is completed.

6. An access point device of a wireless communication system that performs wireless communication with a plurality of station devices, the access point device comprising:
a processor that, after notifying the plurality of station devices of a schedule of channel transition including identification information of a transition destination channel and a timing of channel transition different for each of station devices or each group of station devices, executes a switching process to the transition destination channel.

7. The access point device according to claim 6, wherein the processor;
sets a stealth mode accompanying execution of the switching process to the transition destination channel, and
cancels the set stealth mode after connection with the station device according to the schedule of channel transition is completed.

8. A non-transitory computer readable memory storing a program for causing a processor to function as the processor of the access point device according to claim 6.

9. One or more non-transitory computer readable memories storing a program for causing the processors of claim 4 to perform the method of claim 4.
